(19) United States
(12) Patent Application Publication
(10) Pub. No.: US 2021/0163724 A1
(43) Pub. Date: Jun. 3, 2021

(54) TEXTURED ARTICLES AND METHODS FOR THEIR MANUFACTURE

(71) Applicant: Keter Plastic Ltd., Herzliya (IL)

(72) Inventors: Reut ITZHAK-SIGRON, Yea'f (IL); Zvi ZAK, Herzliya (IL); Hanna SPAANDER, Tel Aviv (IL); Gali KUDIN AMAR, Rehovot (IL)

(73) Assignee: Keter Plastic Ltd., Herzelyia (IL)

(21) Appl. No.: 16/641,496

(22) PCT Filed: Aug. 30, 2018
(86) PCT No.: PCT/IL2018/050962

§ 371 Date: Feb. 24, 2020

Related U.S. Application Data
(60) Provisional application No. 62/552,439, filed on Aug. 31, 2017.

(51) Int. Cl. C08L 23/12; B29C 45/37; B29C 45/00; B44F 9/00; B44C 1/22

(52) U.S. Cl. CPC C08L 23/12; B29C 45/372; B29C 45/0001; B29K 2105/0094; B44C 1/221; B44C 1/227; B44C 1/228; B44F 9/00

(57) ABSTRACT

Provided are textured articles, compositions and processes for their manufacturing, specifically molded articles, having textured or patterned, e.g. randomly-textured, surfaces. In particular, the disclosure concerns compositions and processes for manufacturing molded polymer-based articles that visually and texturally mimic or imitate various materials, such as concrete, marble, ceramics, wood, etc.

### TECHNOLOGICAL FIELD

The present disclosure concerns textured articles, compositions and processes for their manufacturing, specifically molded articles, having textured or patterned, e.g. randomly-textured, surfaces. In particular, the disclosure concerns compositions and processes for manufacturing molded polymer-based articles that visually and texturally mimic or imitate various materials, such as concrete, marble, ceramics, wood, etc.

### BACKGROUND ART

References considered to be relevant as background to the presently disclosed subject matter are listed below:
U.S. Pat. No. 7,790,784
WO 97/24209
WO 12/041843

Acknowledgement of the above references herein is not to be inferred as meaning that these are in any way relevant to the patentability of the presently disclosed subject matter.

### BACKGROUND

Molded articles, i.e. articles which are made of plastic material and manufactured in various molding techniques are known. Such articles often have a homogenous color and texture, or have defined or repetitive patterns (e.g. images, text, lines, dots, etc.) on their surface for decorative purposes. These articles are typically identified by the consumer as made of plastic material, sometimes associated with lower quality products.

Molded articles mimicking natural or mineral-based materials have been produced. Concrete or stone mimicking composition are often produced by mixing mineral aggregates into a polymer-based binding matrix; for example, U.S. Pat. No. 7,790,784 describes compositions for producing simulated stone, masonry and brick textured products. These compositions comprise a polymer, 1-50 wt % of a mineral aggregate, 0.01-10 wt % adhesive and at least one colorant.

Another example is described in WO 12/041843, in which polymeric concrete is prepared by using a polymer binder system and at least 60 wt % inorganic filler.

Other techniques are based on using a combination of different pigments to obtain a visual effect. WO 97/24209 describes a process for creating aesthetically pleasing multicolor design or pattern by geometrically loading different colored casting material into three-dimensional arrays within a holding container to obtain particular colored designs.

### GENERAL DESCRIPTION

The present disclosure concerns compositions and processes for manufacturing articles, specifically molded articles, having textured, e.g. randomly-textured, surfaces, as well as to articles produced from such compositions and/or by such methods. In particular, the disclosure concerns compositions and processes for manufacturing polymer-based injection-molded articles, which are imparted with randomly-distributed imperfections or randomly-distributed coloration, thus resulting in visually and texturally mimicking or imitating composite naturally-based materials.

The term composite naturally-based materials is meant to denote composite materials which comprise a natural (i.e. product of nature) constituent as their main component, either mineral-based or organic material. The term means to denote composite materials which are found as such in nature, e.g. stone or marble, or composite materials are constituted predominantly from natural constituents, such as cement, clay, ceramics, plaster, chalk, etc. Exemplary organic natural materials may be various types of wood and composite materials based thereon (e.g. wood-chip boards). As such materials are products of nature, each article produced therefrom will have a different texture and visual features; typically, two articles made of the same natural material will not have identical texture and/or visual appearance.

The compositions and processes of this disclosure are employed to obtain synthetic, i.e. polymer-based, articles which have a texture and/or visual features that mimic or imitate the texture and/or appearance of a composite naturally-based material with high degree of similarity to the mimicked or imitated composite naturally-based material.

Thus, in a first aspect of this disclosure, there is provided a composition for injection-molding a textured (i.e. randomly-textured) article, the composition comprising at least one first polymer having a melt flow index (MFI) of at most about 8 g/10 min, at least one second polymer having a melt flow index of at least about 12 g/10 min, at least one mineral-based additive, at least one blowing agent and at least one pigment.

In another aspect, this disclosure provides an injection-molded article textured (i.e. randomly-textured) over at least a portion of its external surface to mimic or imitate a composite naturally-based material, the article being made from a composition comprising at least two polymers, e.g. at least one first polymer having a melt flow index (MFI) of at most about 8 g/10 min and at least one second polymer having a melt flow index of at least about 12 g/10 min, at least one mineral-based additive and at least one pigment.

A further aspect of this disclosure provides a process for manufacturing a molded article, the article being textured (i.e. randomly-textured) over at least a portion of its external surface to mimic or imitate a composite naturally-based material, the process comprising injection-molding a composition as described herein in a mold to obtain a molded article, and, optionally, texturing at least a portion of an external surface of the molded article (either in-mold and/or after molding).

In another aspect, the present disclosure provides for a molded article that is textured (i.e. randomly-textured) over at least a portion of its external surface and mimicking or imitating a composite naturally-based material manufactured by the processes described herein.

### DETAILED DESCRIPTION OF EMBODIMENTS

Compositions and processes of this disclosure are designed for the manufacture of molded articles that mimic composite naturally-based materials in a realistic manner; namely, the compositions and processes of this disclosure enable obtaining molded articles, made predominantly of polymeric materials (or having polymeric materials as their major constituents), which are realistic imitations of composite naturally-based materials in a visual and/or textural manner. For example, an article produced from the compositions or by a process of this disclosure with the purpose of mimicking a concrete article may have an external surface comprising a combination of surface defects, such as air bubbles, cracks, edge defects, strikes, veins, variable color distribution, shadings and cloudiness, all being visual and textural features of articles being made of concrete. However, unlike concrete, which predominantly comprises mineral-based materials and mineral aggregates, the articles of this disclosure are polymer-based and can thus be manufactured in a molding, e.g. injection molding, process.

The term randomly-textured or any lingual variation thereof is meant to denote areal variability in texture of the textured surface, such that the textural features of a given area unit of the textured surface are different from one area unit of the textured surface to another, as well as the texture being random within a given area unit of the textured surface (e.g. a unit area of 1 cm²). Namely, two identically-sized unit areas in the textured surface will be different in their textural features, and each of said unit areas will have a random texture within said unit. Texture or textural features is meant to encompass physical textural features (i.e. roughness, physical imperfections, etc.) as well as visual features (i.e. change in color, shades, local pigmentation, etc.).

According to a first aspect of this disclosure, provided is a composition for injection-molding a textured (i.e. randomly-textured) article, the composition comprising at least one first polymer having a melt flow index (MFI) of at most about 8 g/10 min, at least one second polymer having a melt flow index of at least about 12 g/10 min, at least one mineral-based additive, at least one blowing agent and at least one pigment.

The term melt flow index (MFI) denotes the ease of flow of a polymer melt under defined conditions. Namely, the higher the MFI, the more flowable the polymer melt is, and it is easier distributed or fills the injection molding mold during the injection-molding process. Unless otherwise specifically indicated, the MFI values provided herein are measured according to ASTM D1238 international standard (and/or ISO 1133).

The composition of this disclosure combines polymers having different MFI values, and specifically, at least one polymer that has an MFI value of at most about 8 g/10 min and at least one polymer having an MFI value of at least about 12 g/10 min. It is noted that typical MFI values suitable for injection-molding processing is at least 12 g/10 min, typically in the range of 12 to 150 g/10 min, such that polymers having an MFI value of below 12 g/10 min are usually considered unsuitable and undesired for molding, i.e. injection molding processes. Therefore, the composition of this disclosure includes a unique combination on high-MFI polymer(s) together with a very low-MFI polymer, that can still be processed in injection-molding, although a major component thereof (the low-MFI polymer) is traditionally not used, or considered unsuitable for use, in such processes. This unique combination enables the composition to have variable flow properties, namely during injection molding of the composition each unit volume of the composition may have different flow properties, thus creating an uneven flow of the molten composition within the mold. Such uneven flow distributes the additional components of the composition, e.g. the blowing agent, the mineral-based additives and the pigments, thus resulting in a randomly-texturized surface of the article.

In some embodiments, the first polymer has an MFI value of at most about 8 g/10 min. In other embodiments, the MFI value of the first polymer may be at most about 7 g/10 min, 6 g/10 min, 5 g/10 min, 4 g/10 min, 3 g/10 min or even at most about 2 g/10 min. In some other embodiments, the first polymer may have an MFI value of between about 1 g/10 min and about 8 g/10 min, between about 1 g/10 min and about 5 g/10 min, or even between about 1 g/10 min and 4 g/10 min.

According to some embodiments, the second polymer has an MFI value of at least about 12 g/10 min. In other embodiments, the MFI value of the second polymer may be at least about 15 g/10 min, 20 g/10 min, 25 g/10 min, 30 g/10 min, 40 g/10 min, 50 g/10 min, 60 g/10 min, 70 g/10 min, 80 g/10 min, 90 g/10 min or even at least about 100 g/10 min. In some other embodiments, the second polymer may have an MFI value of between about 12 g/10 min and about 150 g/10 min, between about 12 g/10 min and about 120 g/10 min, or even between about 12 g/10 min and 100 g/10 min.

Each of the first and second polymers is typically a thermoplastic polymer. The first and second polymers may be of the same chemical group (e.g. the polypropylenes group, the polyethylenes group, etc.) however differing in their MFI values, or may be of different chemical groups. In some embodiments, each of the first and second polymers may be independently selected from polypropylene, polyethylene, polystyrene and blends and co-polymers thereof. In other embodiments, both the first polymer and the second polymer are from the polypropylenes group.

It is noted that the composition may, at times, comprise additive polymers (i.e. in small quantities, typically up to 2-5 wt %), such as low density polyethylenes (linear or non-linear), co-polymers of styrene, polycarbonates, polyesters, polycaprolactones, polyethylene-terephthalate (PET), and other suitable thermoplastic polymers.

The term polymer or polymeric material includes homopolymers, copolymers, such as for example, block, graft, random and alternating copolymers as well as terpolymers, further including their derivatives, combinations and blends thereof. In addition to the above the term includes all geometrical configurations of such structures including linear, block, graft, random, alternating, branched structures, and combination thereof. The term block copolymer is meant to encompass a polymer formed from two or more homo-polymer subunits (blocks) linearly linked by chemical bonds (i.e. the blocks are connected end-to-end). Block copolymers with two, three, four and multiple homo-polymer units are referred to as di-block, tri-block, tetra-blocks and multi-blocks respectively. The number of monomer types in a block co-polymer may be less than or equal to the number of blocks. Thus, an ABC linear tri-block consists of three monomer types, whereas an ABA linear tri-block consists of two monomer types.

In some embodiments, the composition comprises at least about 20 wt % of said at least one first (low-MFI) polymer. In other embodiments, the composition may comprise between about 20 and about 70 wt %, between about 22 and about 70 wt %, between about 25 and about 70 wt %, between about 27 and about 70 wt %, or even between about 30 and about 70 wt % of said first polymer. In other embodiments, the composition may comprise between about 20 and about 68 wt %, between about 20 and about 65 wt %, between about 20 and about 62 wt %, or even between about 20 and about 60 wt % of said first polymer. According to some other embodiments, the composition may comprise between about 22 and about 68 wt %, between about 25 and about 65 wt %, between about 27 and about 62 wt %, or even between about 30 and about 60 wt % of said first polymer.

The at least one second polymer may be used in compositions of this disclosure as such, i.e. as a pure component, or may be part of other components of the composition. For example, as will be further elaborated below, some of the components of the composition may be provided as granules or pellets that are constituted by said second polymer and an additional component (for example, granules of polymer that are coated or embedded with the mineral-based additive). Thus, according to some embodiments, the total amount of the second (high-MFI) polymer in the composition may be at least about 5 wt %. In other embodiments, the composition may comprise a total amount of between about 5 and about 40 wt %, between about 7 and about 37 wt %, or even between about 10 and about 35 wt % of said second polymer.

It is noted that, according to some embodiments, the weight ratio (w/w) of the first polymer to the second polymer of at least about 1 (namely at least 1:1 ratio), more typically at least about 1.1, at least about 1.2, at least about 1.3, at least about 1.4, at least about 1.5, at least about 2, at least about 2.5, at least about 3, at least about 3.5 at least about 4, at least about 5, or at times even at least about 6 (i.e. 6 parts by weight of the first polymer per 1 part by weight of the second polymer). Thus, according to some embodiments, the amount of said at least one first polymer in the composition is at least about the same, or more typically larger than the total amount of the second polymer in the composition.

The composition comprises at least one mineral-based additive. In the context of the present disclosure, the term mineral-based is meant to denote a component that is organo-metallic or non-organic. The mineral based additive may be selected from a carbonate, a silicate, an oxide, a hydroxide and any other mineral material, as well as any mixture thereof. The mineral-based additive may be a mixture, an alloy or a complex of two or more mineral-based materials. In some embodiments, the mineral-based additive is selected from talc (talcum or magnesium silicate and its derivatives), calcium carbonate, chalk, plaster, gypsum, metal-oxide, glass, ceramics and any other suitable mineral-based material. According to some embodiments, the mineral-based additive is talc or a derivative thereof.

The mineral-based additive is typically provided in the form of a fine loose particulate material (i.e. fine powder), having an average particle size of between about 0.1 and about 100 μm (micrometers). At times, the mineral-based additive is provided in the form of fine particles embedded or agglomerated together with said second polymer.

Regardless of the form in which the mineral-based additive is provided, its amount in the composition is at least about 10 wt %, at times between about 10 and about 35 wt %, or even between about 15 and 30 wt %.

The composition also comprises a blowing agent, which is a compound or a formulation that at least partially decomposes into gaseous product(s) due to a chemical reaction with one or more of the components in the composition or when heated above a decomposition temperature. In addition to forming air bubbles in the composition during injection-molding thus reducing final density of the produced article, the bubbles also function to push or carry the components that are in particulate form to towards the surface of the article, thus contributing to the formation of the random texture on the surface of the article produced from the composition. Any suitable blowing agent that decomposes to at least one gaseous product at the temperature of the injection-molding process may be use. Non-limiting examples of such blowing agents are bicarbonate compounds, e.g. sodium bicarbonate. The blowing agent may be present in the composition in an amount of between about 0.5 and about 3 wt %, typically between about 0.5 and about 2 wt %.

As noted above, in order to obtain various texturization and coloration effect on the surface of the article produced from the composition, the composition comprises at least one pigment, typically two or more pigments. The term pigment refers to a chemical agent rendering the composition with a desired color or other desired visual effect. The pigment may be, for example, a chromophore, a salt, an encapsulated pigment powder, thermochromic pigments, fluorescent pigments, security tagging agents, inorganic pigments, organic pigments, etc. The term also encompasses metallic particles, magnetic particles, conductive pigments, glass or ceramic particles (frit), luminescent pigments, etc.

The pigment(s) may be provided at any desirable form, e.g. powder, liquid, solution, suspension, gel or granules (or pellets) of said second polymer that carry or embed the pigment(s). Each of the pigments may independently be organic, non-organic or organo-metallic. The total amount of pigments in the composition may be between about 0.5 and about 5 wt %, at times between about 0.5 and about 3 wt %.

The composition may further comprise one or more texturization additives. In some embodiments, the composition further comprises one or more texturization additive in the form of fibers. The fibers may be made of any desirable material, e.g. polymers, metal, ceramics or glass; typically the fibers are glass fibers. The fibers may be provided as such, or as granules (or pellets) of said second polymer that carry or embeds the fibers. In some embodiments, the amount of fibers in the composition is up to about 10 wt %, typically between 1 and 10 wt %.

Other texturization additives may be at least one of a non-organic additive, an organo-metallic additive and an organic additive. The additive may be in liquid, solution, suspension, gel, or solid form.

In some embodiments, the at least one texturization additive may be in a solid form selected from a powder, flakes, granules, fibers, spheres or any other geometrical form. In such embodiments, the non-organic or organo-metallic texturization additive may be selected from a mineral, a salt, an oxide, ceramic, and glass. When in solid form, the at least one non-organic or organo-metallic texturization additive may have an average particle size of less than 500 μm. Namely, the composition, and as a result the molded article, is substantially devoid of non-organic or organo-metallic texturization additives having an average particle size of more than 500 μm.

In other embodiments, the texturization additive may be an organic additive, being at least one polymeric material in particulate form having a melting temperature that is higher than a temperature in which the injection-molding is carried out. The polymeric material of the organic texturization additive may be of the same chemical family as the first and/or second polymers material of the composition, however differing in molecular weight or chain alignment (e.g. polypropylene having different molecular weights or polyethylene of different chain alignment degrees), or may be a different polymer from the first and/or second polymers of the composition.

By an embodiment, the at least one organic texturization additive is a polymeric material in particulate form that has an average particle size of at least 0.5 mm. Due to its higher melting temperature, such particulate polymeric material remains in distinct particulate form during and after molding, mimicking, for example, mineral aggregates in concrete-imitating molded articles.

The term average particle size refers to the arithmetic mean of measured particles' diameters, wherein the diameters range±25% of the mean. The average particle size of non-spherical particles is given as the average length of the long axis of the particle.

The composition may, by some embodiments, further comprise at least one functional additive. In some embodiments the functional additive may be one or more additives selected from the group consisting of foaming agents, surfactants, UV stabilizers, radical scavengers, anti-oxidants, matting agents, and plasticizers.

In some embodiments, the composition is a dry-blend composition (i.e. a mixture of substantially solid or dry components).

In another aspect, this disclosure provides an injection-molded article textured (i.e. randomly-textured) over at least a portion of its external surface to mimic or imitate a composite naturally-based material, the article being made from a composition described herein.

Thus, the textured (i.e. randomly-textured) injection-molded article of this disclosure comprises at least two polymers, e.g. at least one first polymer having a melt flow index (MFI) of at most about 8 g/10 min and at least one second polymer having a melt flow index of at least about 12 g/10 min, at least one mineral-based additive and at least one pigment. The textured injection-molded article may also comprise at least one blowing agent and/or decomposition products thereof. The article may also comprise any of the texturization and/or functional additives described herein.

It is noted, that in addition to the random texturization of the article's surface, the article may also have a non-homogenous density. In other words, unlike transitional injection-molded articles, the article of this disclosure may have density variations, such that the density of a given volume unit of the textured article is different from one volume unit of the article to another, as well as the density being non-homogenous within a given area volume of the article (e.g. a volume unit of 1 cm³). Namely, two identically-sized unit volumes in the textured article will be different in their density, e.g. having up to about 20% difference in densities and/or having a density of about ±10% from the theoretical maximum (calculated) density.

The article may be a flexible or rigid article, which may be substantially two-dimensional (a thin flat article), a three-dimensional curved (non-flat) article or a voluminous body. The article may be a substantially solid, i.e. monolithic body, may be hollow or may have holes, dimples, through-holes, bores, etc.

The term external surface means to denote any surface of the article that is visible to the user. The portion of the article's external surface may be of any size and structure, the portion may be continuous or comprise of several non-continuous sub-regions on the article's external surface. In some embodiments, the surface of the article is substantially two-dimensional. In other embodiments, the surface is that of a three-dimensional article. In other embodiments, the at least one portion of the article's surface is its whole surface.

As noted above, this disclosure also provides a process for manufacturing a molded article, i.e. an injection-molded article, that is textured (i.e. randomly-textured) over at least a portion of its external surface to mimic or imitate a composite naturally-based material. The process of this disclosure comprises molding a composition described herein in a mold to obtain a textured molded article

In some embodiments, in-mold texturing may be carried out concomitantly with said molding. Namely, texturing may occur within the mold when the mold has a textured surface with which the composition at least in partial melt form comes into contact during molding. This is known as “in-mold” texturing. In such embodiments, the surface of the mold may be a priori textured by at least one method known per se, e.g. selected from the group consisting of laser texturing, chemical etching, sand blasting and any other method known per-se for texturing the mold prior to molding.

Due to the utilization of at least two polymers differing in their MFI values, and specifically utilizing a first polymer having a particularly low MFI value, further texturing is obtained due to the differences in the flowability of the polymers in the molten composition, resulting in random distribution of the various additives and pigments during molding. Alternatively, and/or in addition to said in-mold texturing, further texturing may be obtained by employing specific flow regimens of the composition within the mold or within different sections, segments or portions of the mold. For example, flow of the molted composition within the mold can be controlled to have various velocities near the contact surface with the mold, such that visible flow marks and streak-marks may be obtained onto the surface of the molded article during molding.

A mold having a surface texturized by various techniques allows to combine various visual and textural effects on the molded article's surface, for obtaining a realistic imitation of the composite naturally-based materials. For example, physical texturing such as laser texturing and chemical texturing (e.g. chemical etching) can be used to create fine local imperfections such as micro-cracks, local spots and indentations, as well as shadowing effects, while sand blasting may be used to modify surface roughness that contributes to the realistic “feel” and “look” of the molded article as well as creating diverse light returns from the product hence variation in color appearance. Various texturing techniques may also be used to create surface air bubbles (with or without undercuts), edge-defects, graining, etc. to further improve mimicking of the composite naturally-based materials

In other embodiments, the process comprises a step of secondary texturing of at least a portion of the article's external surface after its extraction from the mold. Namely, a textured molded article is first obtained by a molding step, and after its extraction from the mold, at least a portion of its external surface is further textured by one or more secondary texturing steps. Secondary texturing after the article has been extracted from the mold may be carried out by at least one method selected from the group consisting of laser texturing, chemical etching, sand blasting, etc.

According to some embodiments, texturing may be carried out in two stages: (i) primary texturing concomitantly with molding (i.e. as a result of utilization of the composition described herein, with or without in-mold texturing), and (ii) secondary texturing after extraction of the molded article from the mold.

Molding may be carried in any molding method known per-se and suitable for obtaining the desired geometry of the molded article. In some embodiments, said molding is injection molding.

The process may comprises a pre-step, i.e. prior to molding, of preparing the composition prior to molding. In some embodiments, preparation of said composition comprises mixing the compositions components in a pre-defined mixing order.

In some embodiments, such mixing may include adding the at least one pigment to the composition under conditions permitting non-homogenous distribution of the pigment in the composition. In other embodiments, preparation of said composition comprises mixing said at least one pigment into the composition under conditions permitting forming pigment agglomerates in the mixture.

When the pigment and/or additive is said to be non-homogenously distributed in the composition, it is meant that the concentration of the pigment and/or additive is different from one volume unit to the other of the composition (i.e. the concentration in a volume of composition will contain different concentrations of said pigment and/or additive compared to the same volume taken from a different location of the composition). The term is also meant to encompass non-homogenous dispersion of the pigment and/or additive in the composition, such that visible local areas of high concentration of pigment and/or additive are formed in the composition (for example by agglomeration).

The conditions permitting non-homogenous distribution of the pigment and/or additive in the composition may be, for example, partial mixing of said pigment and/or additive into the composition, over-mixing said pigment and/or additive in the composition to form agglomerates, selecting pigments and/or additives which poorly wetted by the polymer melt as to facilitate formation of agglomerates, selecting pigments and/or additives which have a melting point higher than the melting temperature of the polymeric components, etc.

The non-homogenous distribution of the pigments and/or additives enables obtaining various visual and textural effects, such as localized cloudiness, uneven shades, local differences in gloss/mat ratio, streak or spread marks, irregular spots and stains, etc.

The pigment(s) and additive(s) may be added to the polymeric components prior to or during melting. Namely, in some embodiments, preparation of the composition comprises melting one or both of said first and second polymers to obtain a polymeric material melt, and mixing said at least one pigment, the mineral-based additive and the blowing agent into the polymeric material melt to thereby obtaining said composition. In other embodiments, preparation of the composition comprises mixing all components in a single step to obtain the composition.

The term melt form refers to a physical state of the polymers or polymeric material which is between a solid state and a liquid state, substantially without utilization of any solvent.

It is to be understood that the processes of the present disclosure involve numerous process steps which may or may not be associated with other common physical-chemical processes so as to achieve the desired visual or textural effect. Unless otherwise indicated, such process steps, if present, may be set in different sequences without affecting the workability of the process and its efficacy in achieving the desired end result. As a person skilled in the art would appreciate, a sequence of steps may be employed and changed depending on various economical aspects, material availability, raw material, environmental considerations, etc.

In another aspect, the present disclosure provides a molded article being textured over at least a portion of its external surface manufactured by the process described herein.

In some embodiments, the texture on said portion of the article's external surface comprises randomly-distributed surface defects. The randomly-distributed surface defects may comprise one or more of air bubbles, cracks, micro-cracks, dents, chips, scratches, cloudiness, spots, stains, graining, edge defects, parting lines, streak-marks, and any other surface defect.

In some embodiments, the molded article has a texture mimicking a composite naturally-based material. The molded article may have a texture and/or visual appearance of a composite naturally-based material selected from stone, earth-ware, clay, ceramics, marble, plaster, concrete, wood, wood-chip, etc.

It is noted that, by some embodiments, the molded article may have, in addition to the randomly-distributed surface defects, an overlaid pattern, formed by molding or any other suitable technique. For example, a molded article having randomly-distributed surface defects to mimic the visual appearance and texture of concrete or marble, may also have an overlaid pattern (i.e. a non-random pattern design) on its surface in the form of an embossed pattern. In such a case, a patterned molded article may be obtained, that simulates a concrete or marble-made patterned article.

As used herein, the term about is meant to encompass deviation of ±10% from the specifically mentioned value of a parameter, such as temperature, pressure, concentration, etc.

Whenever a numerical range is indicated herein, it is meant to include any cited numeral (fractional or integral) within the indicated range. The phrases ranging/ranges between a first indicate number and a second indicate number and ranging/ranges from a first indicate number to a second indicate number are used herein interchangeably and are meant to include the first and second indicated numbers and all the fractional and integral numerals therebetween.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A-1B show articles manufactured from compositions and by methods of the present disclosure.

FIG. 2 shows an injection-molded article manufactured from traditional injection-molded formulations.

### EXAMPLES

Randomly-textured articles that mimic the appearance and texture of concrete were produced from various compositions of this disclosure, as detailed in Table 1. The compositions were injection molded into texturized molds, thus obtaining in-mold texturing. Secondary texturing after extraction from the mold were carried out for some of the articles to impart them with further texturizing artifacts.

TABLE 1
exemplary compositions for mimicking
concrete texture and appearance

| | |
|---|---|
| Exemplary | Exemplary |
| composition 1 | composition 2 |

| | | | | |
|---|---|---|---|---|
| Polypropylene^{a} | 25-30 | wt % | 5-10 | wt % |
| Low-MFI polypropylene^{b} | 25-35 | wt % | 50-70 | wt % |
| Talc | 25-35 | wt % | 25-35 | wt % |
| Blowing agent | <1 | wt % | <1 | wt % |
| Pigments (total) | <2 | wt % | <2 | wt % |

| | | | |
|---|---|---|---|
| Glass fibers | 7-12 | wt % | — |

^{a}MFI = >50 g/10 min
^{b}MFI = <3 g/10 min

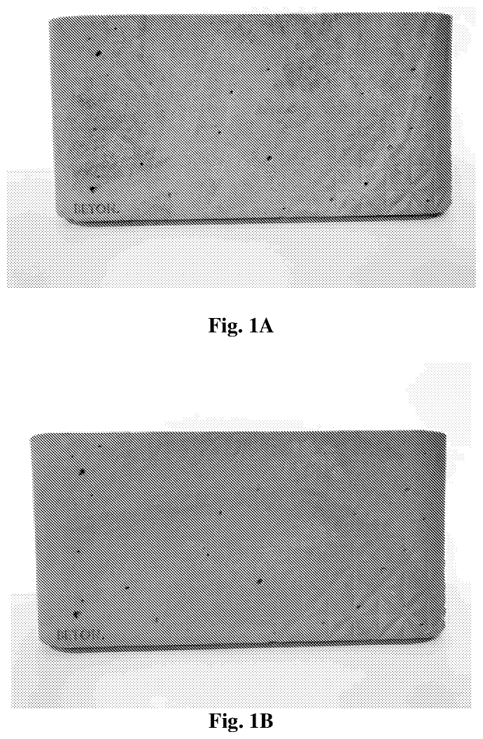

All compositions provided for articles mimicking the tactile feeling and texture as well as the visual appearance of concrete, as shown in FIGS. 1A-1B, such that visually and texturally these articles are almost indistinguishable from similar articles made of concrete. In addition, as seen from FIGS. 1A-1B, various realistic textures and visual effects may be obtained by utilizing the compositions and methods of this disclosure. For example, FIG. 1A shows a box, injection-molded from the compositions of the present disclosure, having a relatively rough surface texture and significantly apparent cloudiness; while in FIG. 1B a similar box that was injection-molded with another composition of the present disclosure shows a more refined random texture and visual features, mimicking a fine-textured concrete article.

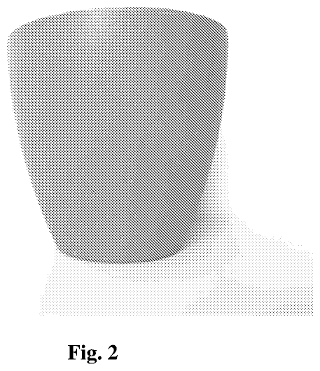

In comparison, FIG. 2 shows an article, injection-molded from traditional compositions. As seen, almost no texturing is visible, and the surface of the article is vary uniform in color, without any apparent texturization or desired visual features, rendering the article with a synthetic look and feel.

1. A composition for injection-molding a textured article, the composition comprising at least one first polymer having a melt flow index (MFI) of at most 8 g/10 min, at least one second polymer having a melt flow index of at least 12 g/min, at least one mineral-based additive, at least one blowing agent and at least one pigment.

2. The composition of claim 1, wherein each of the first and second polymers is a thermoplastic polymer.

3. The composition of claim 2, wherein each of the first and second polymers is independently selected from polypropylene, polyethylene, and polystyrene and blends and co-polymers thereof.

4. The composition of claim 3, wherein both the first polymer and the second polymer are from the polypropylenes group.

5. The composition of any one of claims 1 to 4, the composition comprising at least 20 wt % of said at least one first polymer.

6. The composition of claim 5, wherein the composition comprises between about 20 and about 70 wt %, of said first polymer.

7. The composition of claim 5, wherein the composition comprises between about 30 and about 60 wt % of said first polymer.

8. The composition of any one of claims 1 to 7, wherein the total amount of said second polymer in the composition is at least 5 wt %.

9. The composition of claim 8, wherein the composition comprises a total amount of between about 10 and about 35 wt % of said second polymer.

10. The composition of any one of claims 1 to 9, wherein the weight ratio (w/w) of the first polymer to the second polymer in the composition is at least about 1.

11. The composition of any one of claims 1 to 9, wherein the amount of said at least one first polymer in the composition is larger than the total amount of the second polymer in the composition.

12. The composition of any one of claims 1 to 11, wherein the at least one mineral-based additive is selected from a carbonate, a silicate, an oxide, a hydroxide and any mixture thereof.

13. The composition of claim 12, wherein the mineral-based additive talc or a derivative thereof.

14. The composition of any one of claims 1 to 13, wherein the mineral-based additive is present in the composition in an amount of at least about 10 wt %.

15. The composition of claim 14, wherein the mineral-based additive is present in the composition in an amount of between about 15 and 30 wt %.

16. The composition of any one of claims 1 to 15, comprising between about 0.5 and about 3 wt % of said at least one blowing agent.

17. The composition of any one of claims 1 to 16, comprising a total amount of pigment of between about 0.5 and about 5 wt %.

18. The composition of any one of claims 1 to 17, comprising two or more pigments.

19. The composition of any one of claims 1 to 18, further comprising at least one texturization additive selected from a powder, flakes, granules, fibers, spheres or having an irregular geometrical form.

20. The composition of claim 19, wherein the texturization additive is in the form of fibers.

21. The composition of claim 20, wherein the amount of fibers in the composition is up to about 10 wt %.

22. The composition of any one of claims 19 to 21, wherein the texturization additive is at least one polymeric material in particulate form having a melting temperature that is higher than the melting temperature of the first and the second polymers.

23. The composition of claim 22, wherein said polymeric material in particulate form that has an average particle size of at least about 0.5 mm.

24. The composition of any one of claims 1 to 23, further comprising at least one functional additive, e.g. selected from the group consisting of foaming agents, surfactants, UV stabilizers, radical scavengers, anti-oxidants, matting agents, and plasticizers.

25. An injection-molded article textured over at least a portion of its external surface to mimic or imitate a composite naturally-based material, the article being made from a composition of any one of claims 1 to 24.

26. An injection-molded article textured over at least a portion of its external surface to mimic or imitate a composite naturally-based material, the article comprising at least two polymers, at least one mineral-based additive and at least one pigment.

27. The injection-molded article of claim 26, comprising at least one first polymer having a melt flow index (MFI) of at most about 8 g/10 min and at least one second polymer having a melt flow index of at least about 12 g/min.

28. The injection-molded article of claim 26 or 27, further comprising at least one blowing agent and/or decomposition products thereof.

29. The article of any one of claims 25 to 28, wherein said portion of external surface is randomly-textured.

30. The article of any one of claims 25 to 29, wherein the surface of the article is substantially two-dimensional.

31. The article of any one of claims 25 to 29, wherein the surface is that of a three-dimensional article.

32. The article of any one of claims 25 to 31, wherein the at least one portion of the article's surface is its whole external surface.

33. A process for manufacturing a molded article being textured over at least a portion of its external surface, the process comprising:
molding a composition of any one of claims 1 to 24 in a mold to obtain a texturized molded article.

34. The process of claim 33, wherein said mold is textured on at least a portion of its internal surface.

35. The process of claim 33 or 34, further comprising carrying out secondary texturing of at least a portion of the molded article's external surface.

36. The process of claim 35, wherein said secondary texturing being carried out after extraction of the molded article from the mold.

37. The process of claim 33, wherein said texturing is carried out in two stages: (i) primary texturing concomitantly with said molding (in-mold texturing), and (ii) secondary texturing after extraction of the molded article from the mold.

38. The process of any one of claims 35 to 37, wherein said secondary texturing is carried out by at least one method selected from the group consisting of laser texturing, chemical etching, and sand blasting.

39. The process of any one of claims 33 to 38, wherein said in-mold texturing is obtained by texturing the mold, prior to molding, by at least one method selected from the group consisting of laser texturing, chemical etching, and sand blasting.

40. The process of any one of claims 33 to 39, comprises preparing said composition prior to molding.

41. The process of claim 40, wherein preparation of said composition comprises mixing said at least one pigment and/or mineral-based additive into the polymeric material under conditions permitting non-homogenous distribution of the pigment and/or mineral-based additive in the mixture.

42. The process of claim 40, preparation of said composition comprises mixing said at least one pigment and/or mineral-based additive into the polymeric material under conditions permitting forming pigment and/or mineral based additive agglomerates in the composition.

43. The process of any one of claims 33 to 42, wherein said molding is injection molding.

44. A molded article being textured over at least a portion of its external surface manufactured by the process of any one of claims 33 to 42.

45. The molded article of claim 44, wherein the texture on said portion of the article's external surface comprises randomly-distributed surface defects.

46. The molded article of claim 45, wherein said randomly-distributed surface defects comprise one or more of air bubbles, cracks, micro-cracks, dents, chips, scratches, cloudiness, spots, stains, graining, edge defects, parting lines, and streak-marks.

47. The molded article of any one of claims 44 to 46, wherein said article having a texture mimicking a composite naturally-based material.

48. The molded article of any one of claims 44 to 47, wherein said article having a texture and/or visual appearance of a composite naturally-based material selected from stone, earth-ware, clay, ceramics, marble, plaster, concrete, wood, and wood-chip.

49. The molded article of any one of claims 44 to 48, comprising an overlaid pattern in addition to randomly-distributed surface defects.
